(19) United States
(12) Patent Application Publication
(10) Pub. No.: US 2010/0225902 A1
(43) Pub. Date: Sep. 9, 2010

(54) Methods and apparatus for robotically inspecting gas turbine combustion components

(75) Inventors: Paul C. Bagley, Middleburgh, NY (US); Robert M. Roney, JR., Schoharie, NY (US); Richard Hatley, Convent Station, NJ (US)

Correspondence Address: JOHN S. BEULICK (17851);ARMSTRONG TEASDALE LLP, 7700 Forsyth Boulevard, Suite 1800, St. Louis, MO, 63105, US

(73) Assignee: General Electric Company

(21) Appl. No.: 11/521,628

(22) Filed: Sep. 14, 2006

(51) Int. Cl. G01N 21/88

(52) U.S. Cl. 356/237.1

(57) ABSTRACT

A method is provided for in situ inspection of a wear pad gap in a gas turbine engine combustor. The wear pad gap is defined between a wear pad of a transition piece impingement sleeve and a forward ring of a flow duct of the combustor. The method includes coupling a guide to the combustor such that the guide at least partially extends within a space between the impingement sleeve and a body of the transition piece, displacing an inspection head along the guide within the space between the impingement sleeve and the transition piece body such that the inspection head is positioned adjacent a wear pad, and inspecting the wear pad gap.

### BACKGROUND OF THE INVENTION

This invention relates to a robotic inspection system and method for in situ inspection of gas turbine cannular combustion components for evaluating a condition of the components.

Maintenance costs and equipment availability are two concerns of a gas turbine operator. Maintenance may be performed to reduce equipment downtime and/or provide long-term reliable operation. Maintenance inspections of gas turbines are sometimes broadly classified as standby, running, and disassembly. Disassembly inspections are generally categorized into three types: combustion inspection, hot gas path inspection, and major inspection. All three types of inspections require shutdown and disassembly of the turbine to varying degrees to enable inspection and replacement of aged and worn components. The combustion inspection includes evaluation of several components of the combustion system including the transition piece. The transition piece is a thin-walled duct used to conduct high-temperature combustion gases from the combustion chamber to the annular turbine nozzle passage. The transition piece and other combustion components are generally inspected for foreign objects, abnormal wear, cracking, thermal barrier coating TBC condition, oxidation/corrosion/erosion, hot spots/burning, missing hardware, and/or clearance limits. Components which fall outside established threshold limits may be replaced to maintain optimum operating conditions for the entire system. For example, if not rectified, such conditions can lead to reduced machine efficiency and/or damage to the turbine that, for example, may result in unplanned outages and significant repair costs.

Removal and installation of transition pieces can be a time-intensive operation of combustion inspection, which may significantly contribute to the combustion inspection outage duration and therefore correspond directly to time lost producing power. To remove transition pieces, all upstream components must be removed, i.e., fuel nozzles, water injectors, and/or various other hardware. Each transition piece is then dismounted and removed one by one in sequence through two access openings in the turbine casing. It will be appreciated that for certain gas turbines, there can be as many as fourteen transition pieces requiring removal.

At least some known methods of combustion inspection include removing the transition pieces and other combustion components to facilitate inspection and/or refurbishment. Inspection has included visual methods consisting of the unaided eye with auxiliary lighting. Additionally, visual methods in known problem areas have been enhanced with the use of liquid red dye penetrant to improve visibility of small hairline cracking. Such known inspections may increase the time required for disassembly and/or installation, may increase a lack of direct retrievable defect data for engineering evaluation and/or historical comparison, and/or may increase reliance on human factors.

### BRIEF DESCRIPTION OF THE INVENTION

In one aspect, a method is provided for in situ inspection of a wear pad gap in a gas turbine engine combustor. The wear pad gap is defined between a wear pad of a transition piece impingement sleeve and a forward ring of a flow duct of the combustor. The method includes coupling a guide to the combustor such that the guide at least partially extends within a space between the impingement sleeve and a body of the transition piece, displacing an inspection head along the guide within the space between the impingement sleeve and the transition piece body such that the inspection head is positioned adjacent a wear pad, and inspecting the wear pad gap.

In another aspect, apparatus is provided for inspecting in situ a wear pad gap in a gas turbine engine combustor. The wear pad gap is defined between a wear pad of a transition piece impingement sleeve and a forward ring of a flow duct of the combustor. The apparatus includes an elongate guide, a mount for coupling the guide to the combustor such that the guide at least partially extends within a space between the impingement sleeve and a body of the transition piece and such that a portion of the guide extends adjacent the wear pad. The apparatus also includes a cam follower coupled to the guide for movement along the guide, an inspection head carried by the cam follower, and an actuator coupled to the cam follower for displacing the cam follower along said guide.

In another aspect, an apparatus is provided for inspecting in situ a wear pad gap in a gas turbine engine combustor, wherein the wear pad gap is defined between a wear pad of a transition piece impingement sleeve and a forward ring of a flow duct of the combustor, and wherein a casing of the combustor includes an opening for accessing an external side of the impingement sleeve. The apparatus includes a manipulator having an arcuate segment and a carriage for supporting the segment within the casing, a rail carried by the segment, a first arm carried by the rail for translatory movement therealong and pivotal movement relative to the rail about a first axis generally normal to the axis of rotation of the gas turbine engine, a second arm coupled at one end to the first arm for pivotal movement about a second axis normal to a plane containing the first arm and the second arm, and an inspection head carried by the second arm adjacent an opposite end thereof for pivotal movement about pan and tilt axes perpendicular to one another. The inspection head is configured to be positioned adjacent the wear pad gap on the exterior side of the impingement sleeve. The inspection head includes a feeler gauge coupled thereto for measuring the wear pad gap.

In another aspect, a method is provided for in situ inspection of a wear pad gap in a gas turbine engine combustor, wherein the wear pad gap is defined between a wear pad of a transition piece impingement sleeve and a forward ring of a flow duct of the combustor. The method includes inserting a robotic inspection tool carrying an inspection head through an opening in an outer casing of the combustor, robotically manipulating the tool from a location external of the casing to locate the inspection head adjacent the wear pad on an exterior side of the impingement sleeve, inspecting the wear pad gap using a feeler gauge on the inspection head, and after completion of the inspection, withdrawing the inspection tool from within the outer casing.

### BRIEF DESCRIPTION OF THE DRAWINGS

FIG. 1 is a schematic illustration of an exemplary annular array of combustors for a gas turbine engine.

FIG. 2 is a fragmentary side elevational view of an exemplary combustor flow sleeve and an exemplary transition piece of an exemplary combustor illustrating an access opening.

FIG. 3 is a perspective view of a portion of the flow sleeve and of the transition piece shown in FIG. 2.

FIG. 4 is an enlarged perspective view of a portion of FIG. 3 and illustrating an interconnection between the flow sleeve and transition piece.

FIG. 5 is a cross section of a portion of the interconnection between the flow sleeve and transition piece.

FIG. 6 is a schematic illustration of the movements of an exemplary embodiment of an inspection head of an exemplary embodiment of an exterior manipulator for inspecting exterior portions of an exemplary impingement sleeve of the transition piece shown in FIG. 2.

FIG. 7 is a perspective view illustrating an exemplary embodiment of an exterior manipulator within an exemplary turbine casing adjacent an exemplary impingement sleeve.

FIG. 8 is a view similar to FIG. 7 with an exemplary embodiment of an upper arm and an exemplary embodiment of a forearm of the exterior manipulator shown in FIG. 7 rotated and extended, respectively.

FIG. 9 is an axial end view of an exemplary embodiment of a segmented rail forming part of the exterior manipulator shown in FIGS. 7 and 8.

FIG. 10 is an enlarged view of a segment of the segmented rail shown in FIG. 9 and an exemplary embodiment of a support carriage therefor.

FIG. 11 is an enlarged cross-sectional view of the carriage and segment shown in FIG. 10 illustrating the drive therebetween.

FIG. 12 is a side elevational view in a plane containing an axis of rotation of the gas turbine engine and illustrating an exemplary embodiment of a rail mounting an exemplary embodiment of a shoulder gearbox, in turn mounting the upper arm and forearm of the exterior manipulator shown in FIGS. 7 and 8.

FIG. 13 is a plan view of the rail shown in FIG. 12.

FIG. 14 is an enlarged cross-sectional view of an exemplary embodiment of a gearbox carried by an exemplary embodiment of a slider on the rail shown in FIGS. 12 and 13.

FIG. 15 is a cross-sectional view taken about on line 12-12 of FIG. 14.

FIG. 16 is a fragmentary view of an exemplary embodiment of a lower end of the upper arm shown in FIG. 8, its joint with the forearm, the forearm and inspection head mounted on the end of the forearm.

FIG. 17 is a view similar to FIG. 7 with the upper arm and forearm of the exterior manipulator shown in FIG. 7 rotated and extended, respectively.

FIG. 18 is a view similar to FIG. 2 illustrating an exemplary embodiment of an interior manipulator forming part of an exemplary embodiment of an inspection tool according to the present invention.

FIG. 19 is an enlarged cross-sectional view of the interior manipulator shown in FIG. 18.

FIG. 20 is an end view of an exemplary embodiment of a mounting for the interior manipulator shown in FIGS. 18 and 19 with parts in cross-section.

FIG. 21 is an end elevational view of an exemplary embodiment of an annulus inspection manipulator according to the present invention.

FIG. 22 is a cross-sectional view of the annulus manipulator shown in FIG. 21 taken about on line 18-18 of FIG. 21.

FIG. 23 is a side elevational view of an exemplary embodiment of a distal end of the annulus manipulator shown in FIGS. 21 and 22.

FIG. 24 is a plan view of an exemplary embodiment of a wand tube forming part of the annulus inspection manipulator shown in FIGS. 21-23.

### DETAILED DESCRIPTION OF THE INVENTION

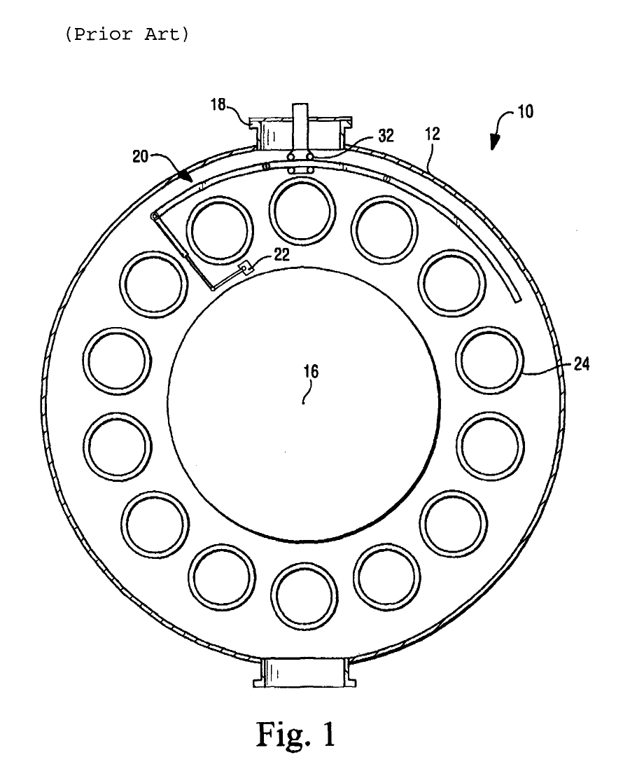

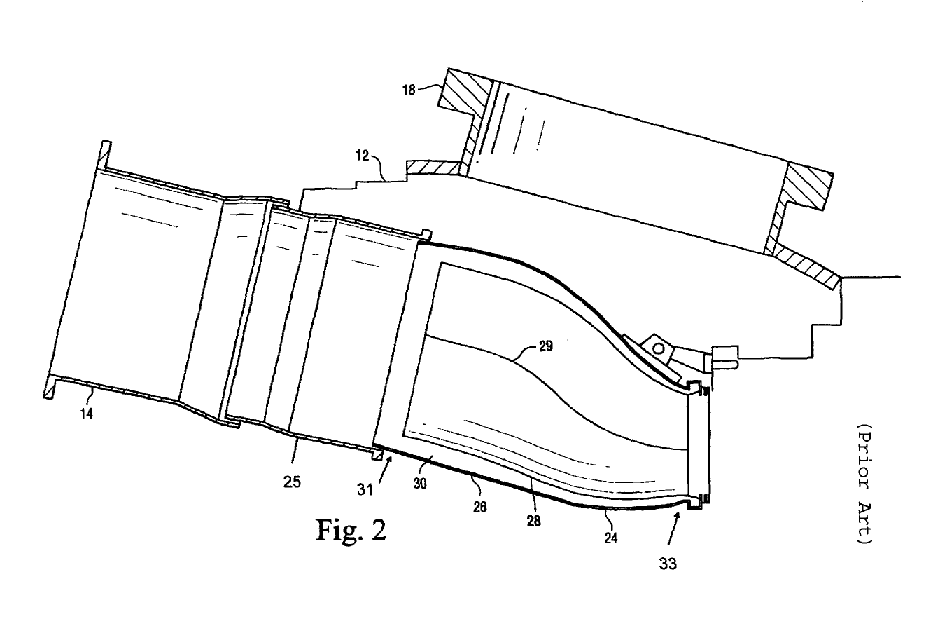

Referring now to the drawings, particularly to FIGS. 1 and 2, there is schematically illustrated an axial view of an exemplary gas turbine engine 10 having an outer casing 12 and an annular array of combustors including combustion flow sleeves 14 within casing 12. Gas turbine engine 10 includes a rotational axis 16. An access opening or manhole 18 through which an external manipulator 20 is inserted for inspecting external surfaces of each of a plurality of impingement sleeves 26 of a plurality of transition pieces 24 within casing 12. By manipulating external manipulator 20, an inspection head 22 may be displaced axially the full length of impingement sleeve 26 as well as positioned at any location about the entire external peripheral surface of impingement sleeve 26.

The combustors each include transition piece 24 and flow sleeve 14 having a forward frame 25. Transition piece 24 includes impingement or perforated sleeve 26 surrounding a transition piece body 28. Body 28 extends generally axially from adjacent a forward end 31 of impingement sleeve 26 and is connected at its aft end 33 to the first-stage nozzle (not shown) of gas turbine engine 10 for flowing hot gases of combustion into the first-stage nozzle. Impingement sleeve 26 and transition piece body 28 are generally circular at their forward ends and flatten out toward their aft ends, terminating in a generally rectilinear opening for flowing the gases into the first-stage nozzle. The surfaces of impingement sleeve 26 and transition piece body 28 generally conform with one another and are spaced one from the other, defining a generally annular space 30 between sleeve 26 and body 28.

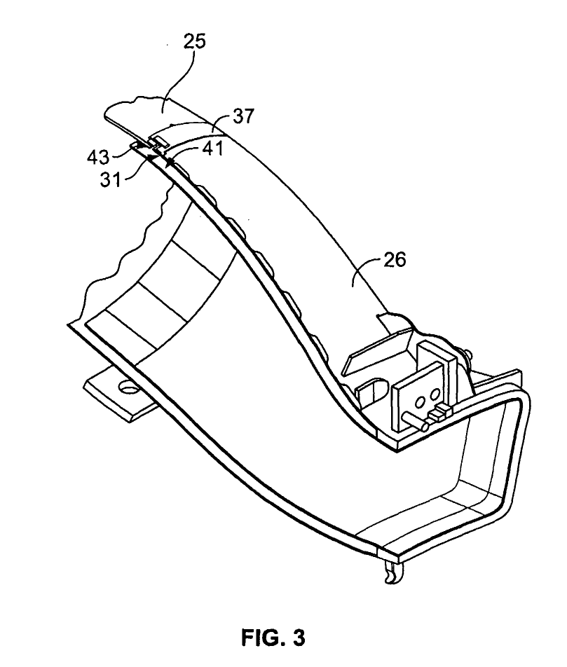

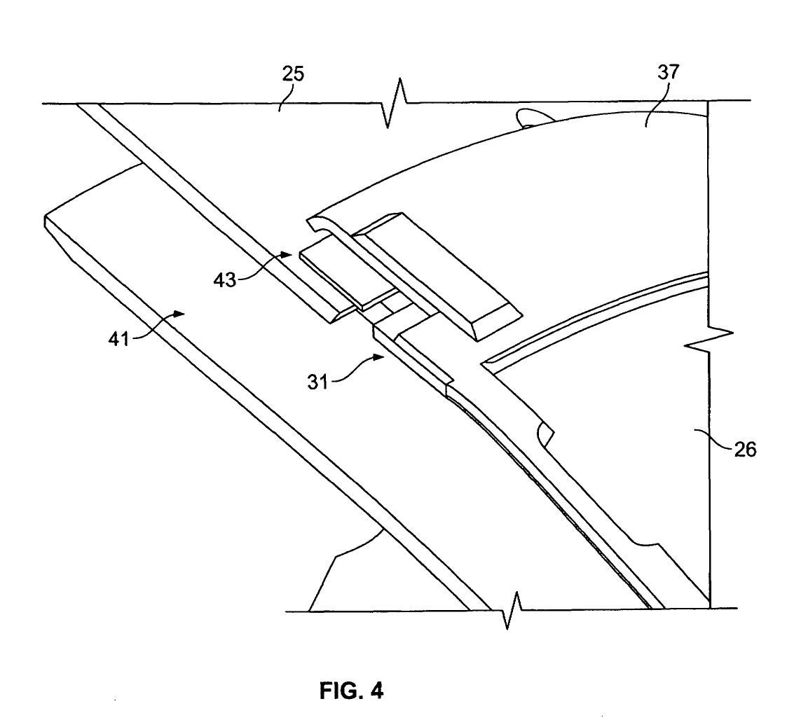

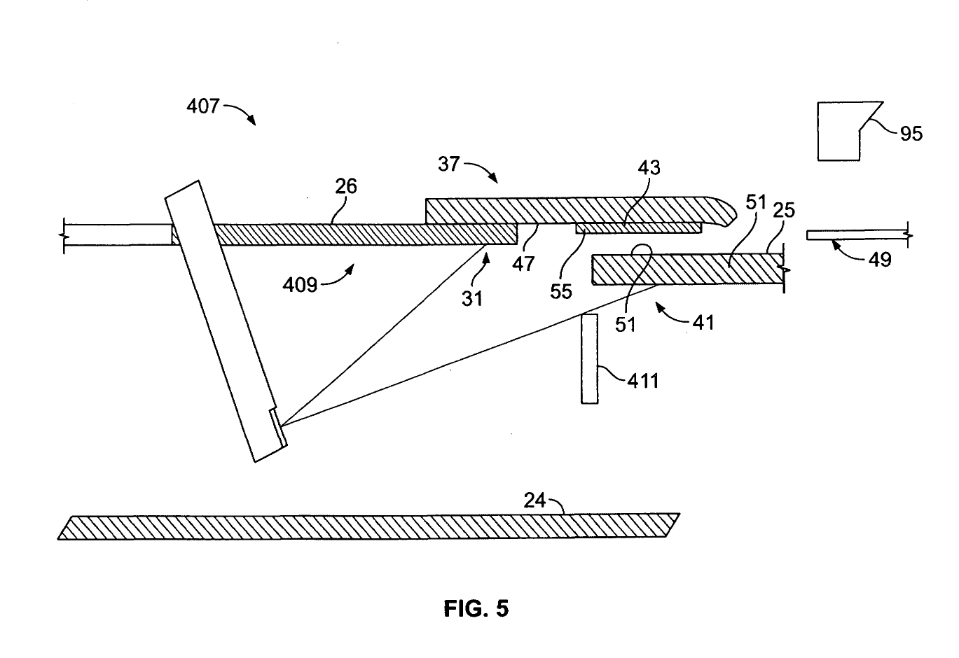

Referring to FIGS. 3, 4, and 5, impingement sleeve 26 is coupled to forward frame or ring 25 using a clamp ring 37. In the exemplary embodiment, clamp ring 37 is welded to impingement sleeve 26. However, clamp ring 37 is not limited to being welded to impingement sleeve 26, but rather may be coupled to impingement sleeve 26 using any suitable method, process, structure, and/or means. Clamp ring 37 extends axially outward from impingement sleeve forward end 31 and coaxially surrounds a portion of an aft end 41 of flow sleeve forward frame 25. A plurality of wear pads 43 are coupled to a radially inner surface 47 of clamp ring 37. In the exemplary embodiment, wear pads 43 are welded to clamp ring 37. However, wear pads 43 are not limited to being welded to clamp ring 37, but rather may be coupled to clamp ring 37 using any suitable method, process, structure, and/or means. Wear pads facilitate proper spacing and alignment of components during thermal expansion. However, over time, wear pads 43 may erode away. Wear pads 43 may also erode away if the wear pads are not installed correctly or manufactured correctly. As wear pads 43 erode away during operation of engine 10, a gap 49, as shown in FIG. 5, may develop between a radially outer surface 51 of forward frame aft end 41 and a radially inner surface 55 of wear pads 43. If gap 49 becomes too large, transition piece 24 may crack due to excessive vibration. The flow sleeve is held in place by stationary pieces at each end. Wear pads 43 and thermal expansion from engine operation create friction and position the components together.

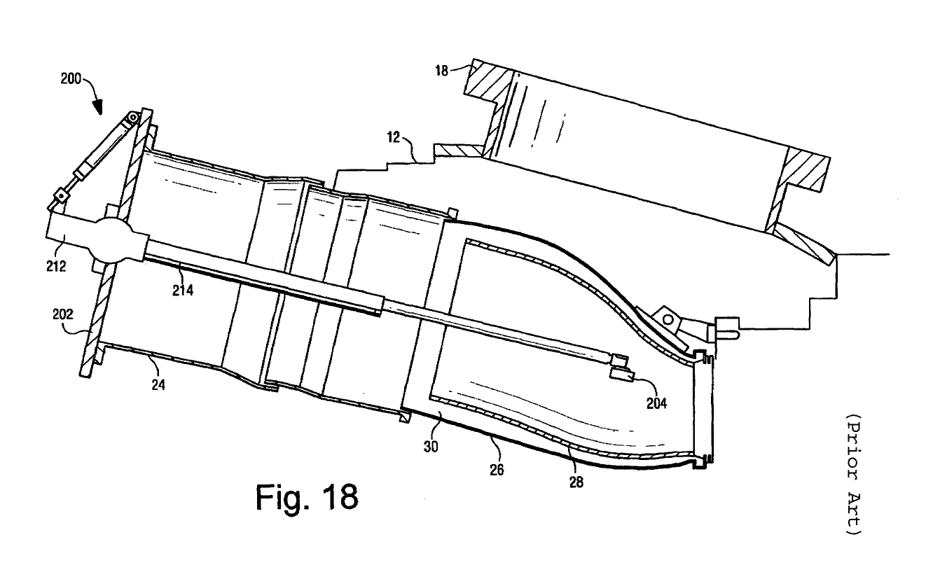

Embodiments of a combustion component inspection system as described herein include three inspection tools, namely: exterior manipulator 20, an interior manipulator 200, and an annulus tool 300 (shown in FIGS. 18, 19, and 21). Exterior manipulator 20 is designed for, but is not limited to, inspecting external surfaces of impingement sleeve 26 for damage to the zipper welds, aft brackets, and/or bullhorns, and/or for inspecting gap 49 between wear pads 43 and forward frame 25. Interior manipulator 200 is designed to inspect the inside surface of the transition piece body 28 for cracking, corrosion and the like and particularly for ensuring that the thermal barrier coating is intact. Annulus 300 tool inspects the exterior surface of side seam welds 29 securing upper and lower halves of transition piece body 28 to one another, and/or inspects gap 49 between wear pads 43 and forward frame 25.

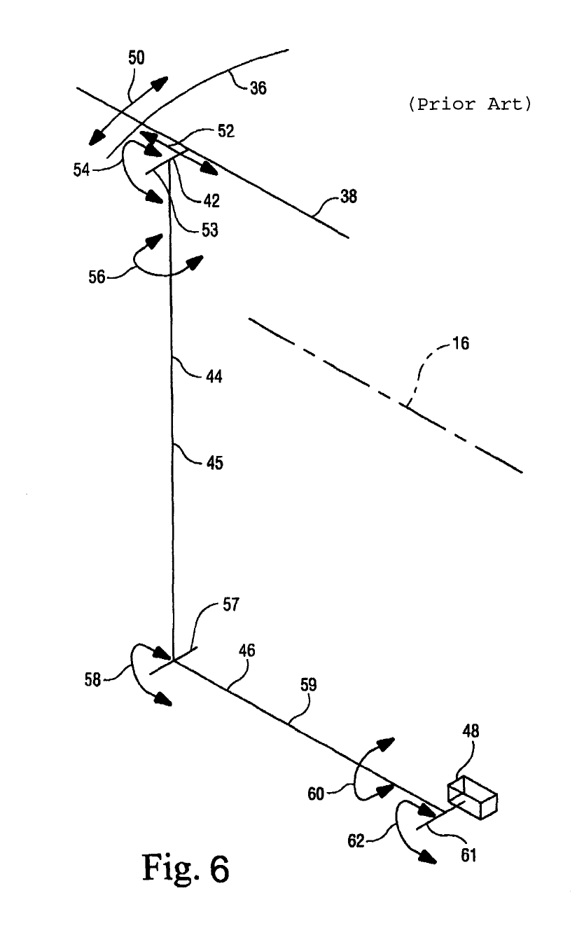

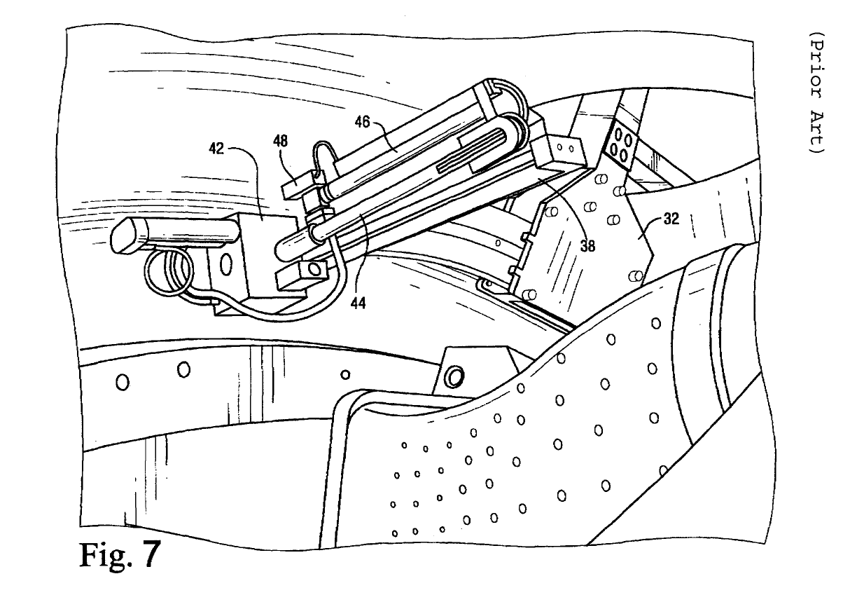

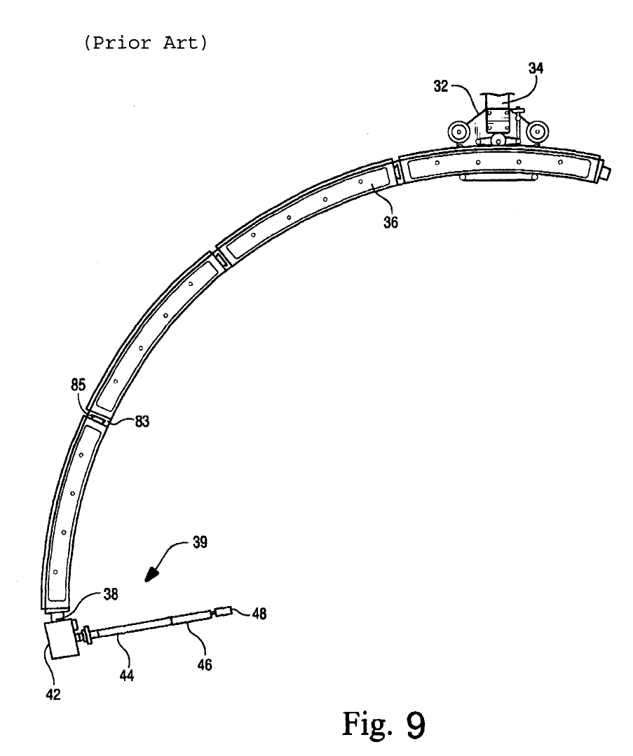

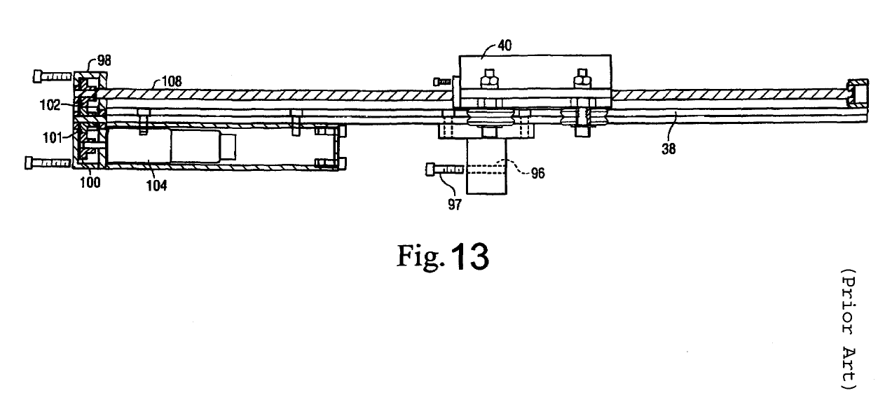

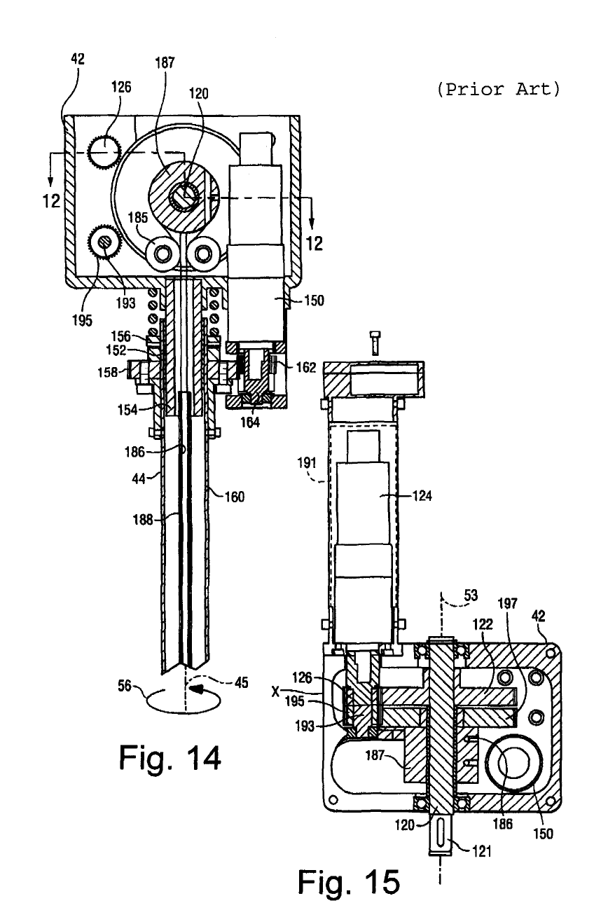

Referring first to the exterior manipulator 20, and with reference to FIGS. 6-9, manipulator 20 is inserted in sections through the access opening 18 and includes an exterior manipulator carriage 32 connected to a mast 34 secured externally of casing 12 to support the manipulator 20 within casing 12. Carriage 32, in turn, supports a plurality of arcuate segments 36 connected one to the other and which segments extend along an arc in excess of 90° in a plane perpendicular to axis 16. It will be appreciated that access openings 18 are provided at locations 180° apart about casing 12. Accordingly, by providing an external manipulator having segments 36 extending in assembly in excess of 90°, inspection head 22 at the end of the segments 36, and having two access openings 18 at locations 180° apart, each impingement sleeve 26 can be inspected by inspection head 22 in each quadrant about axis 16 adjacent access opening 18. The distal end of the arcuate segments 36 carries a robotic inspection system subassembly, generally designated 39 (shown in FIG. 9), including a rail 38 which extends in a general axial direction relative to the turbine rotor axis 16. Rail 38, in turn, carries a slider 40 (shown in FIG. 13) mounting a shoulder gearbox 42 (shown in FIGS. 14 and 15). Projecting from gearbox 42 is an upper or first arm 44 (shown in FIG. 7) pivotally carrying a second arm, i.e., a forearm 46. At the distal end of forearm 46 is an inspection head 48 mounted for movement axially relative to forearm 46 and in pan and tilt directions.

To facilitate an understanding of the movements of the external manipulator 20 prior to describing its component parts, the various motions of the external manipulator will be described with respect to FIG. 6. The arcuate segments 36 lie in a plane perpendicular to axis 16. The rail 38 extends generally parallel to axis 16 and moves with the arcuate segments 36 in a circumferential direction about axis 16 as indicated by the double-ended arrow 50. Shoulder gearbox 42 mounted on slider 40 moves with slider 40 in a generally axial direction along the rail 38, generally parallel to axis 16, thus displacing the upper arm 44, forearm 46 and inspection head 48 in a forward and aft direction generally parallel to axis 16. This linear movement of gearbox 42 is indicated by the double-ended arrow 52 in FIG. 6. The shoulder gearbox 42 also causes rotation of the upper arm 44, forearm 46 and the inspection head 48 carried at the distal end of forearm 46 about a generally tangential first axis 53. The rotary motion about first axis 53 is indicated by the arcuate double-ended arrow 54. Gearbox 42 also rotates the upper arm 44 about its long axis 45 and which rotational movement about rotational axis 45 is indicated by arcuate double-ended arrow 56. Forearm 46 is pivotally mounted to the distal end of upper arm 44 for rotation about a second axis 57 extending through the elbow joint between the upper arm 44 and the forearm 46 and perpendicular to a plane containing upper arm 44 and forearm 46. The rotational direction is illustrated by arcuate double-ended arrow 58 about axis 57 in FIG. 6. It will be appreciated that axes 53 and 57 are also parallel to one another. Inspection head 48 mounted on the distal end of forearm 46 is rotatable in pan and tilt directions. That is, inspection head 48 is rotatable about the axis 59 of forearm 46 in pan and which rotation about axis 59 is indicated by the arcuate double-ended arrow 60. Inspection head 48 is also rotatable in tilt about an axis 61 perpendicular to the axis 59 of forearm 46 and which rotation about axis 61 is indicated by the arcuate double-ended arrow 62. Consequently, it will be appreciated that the inspection head 48 has seven degrees of freedom of movement.

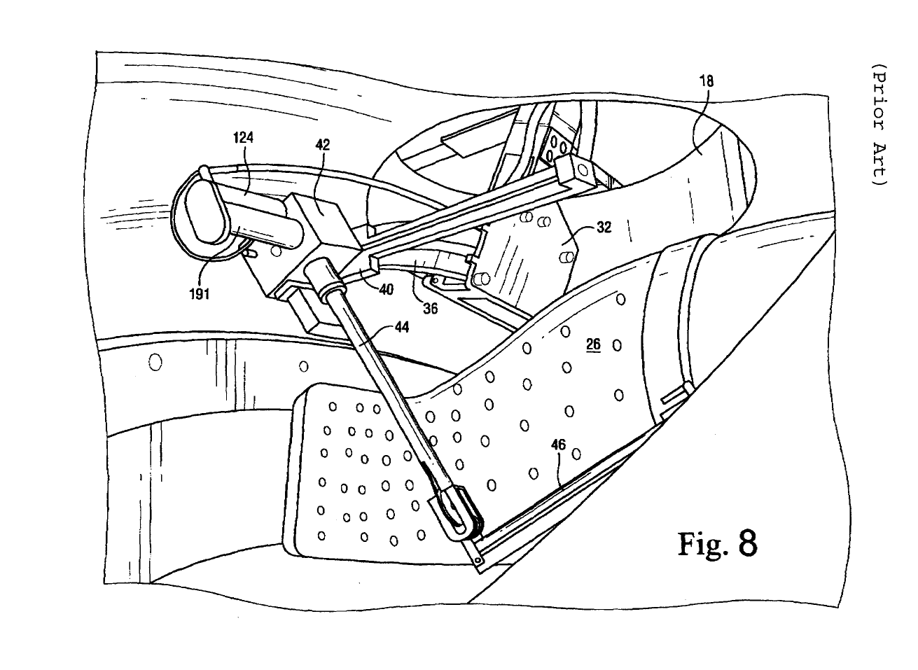

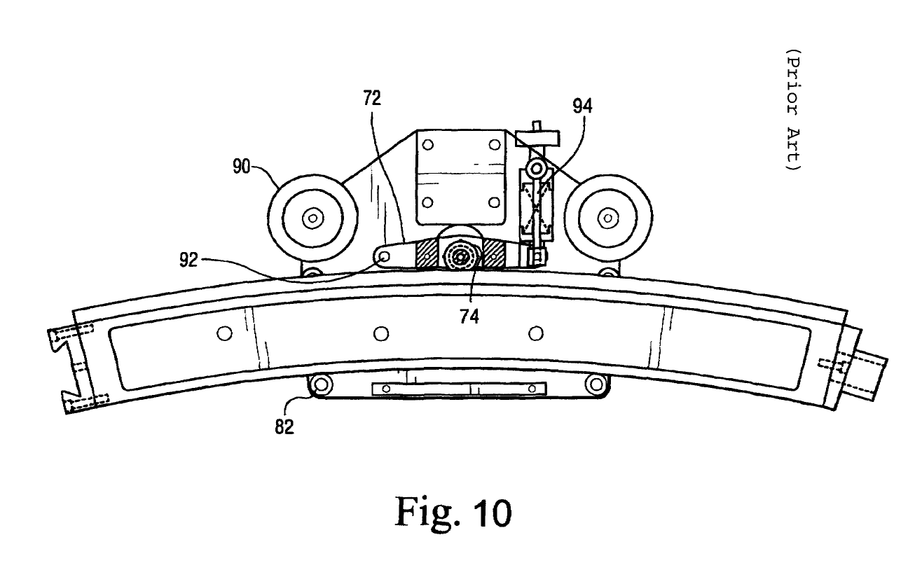

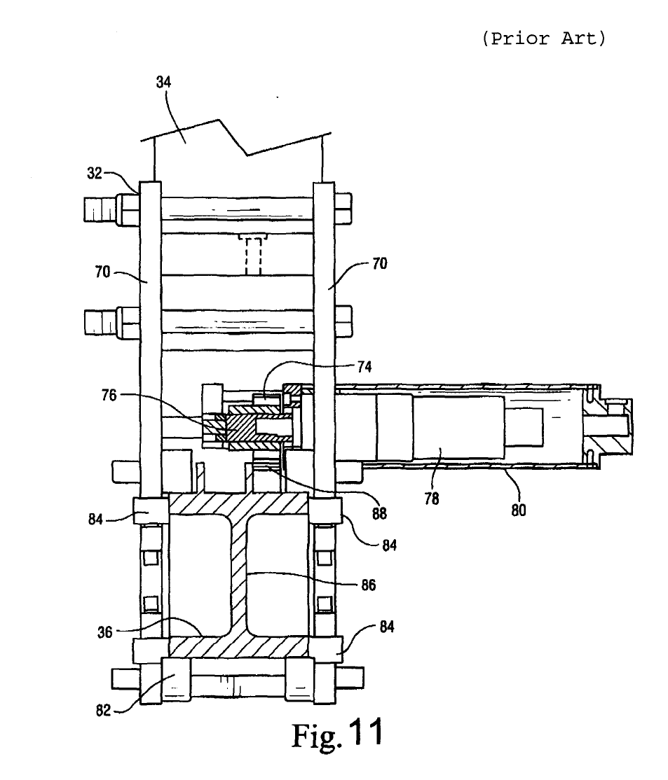

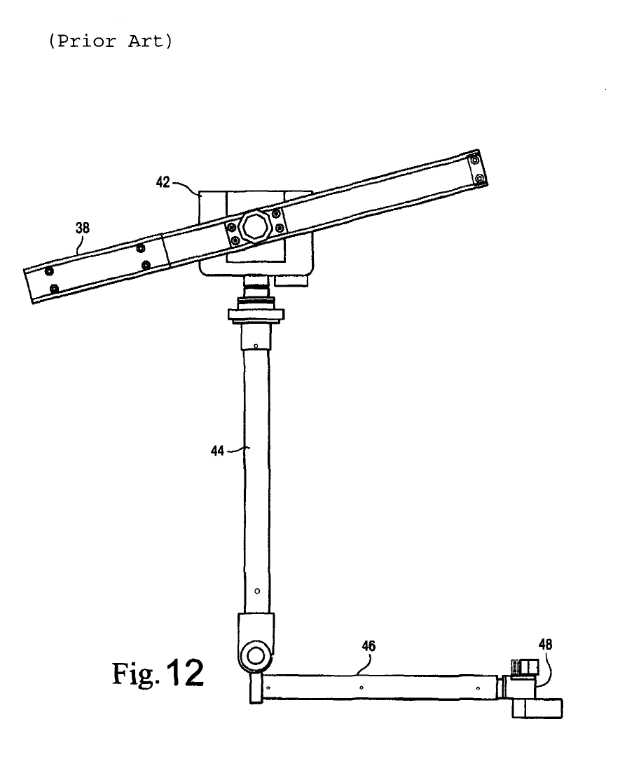

Turning now to the details of the external manipulator 20 and referring to FIGS. 9-13, it will be appreciated that mast 34 (shown in FIG. 9) is supported externally of casing 12 and is preferably fixed to casing 12 (shown in FIG. 1). As illustrated in FIGS. 7 and 8 and to inspect impingement sleeve 26, the carriage 32 is disposed within the casing 12 and supported by mast 34. Referring to FIGS. 10 and 11, exterior manipulator carriage 32 includes spaced mounting plates 70 and a gear carriage 72 between plates 70. Gear carriage 72 includes a centrally located spur gear 74 driven by the shaft 76 of an electric motor 78 carried within a housing 80 secured to the exterior manipulator carriage 32. Plates 70 also carry rollers 82 at opposite ends of the carriage 32 for supporting the arcuate segments 36, as well as side rollers 84 affording lateral support for the segments. As illustrated in FIG. 11, each arcuate segment is in the form of an I-beam 86 and includes a rack gear 88 along an upper surface of the segment. It will be appreciated that the engagement between motor-driven gear 74 carried by the gear carriage 72 and rack 88 drives the arcuate segment 36 along the carriage 32.

To facilitate insertion and removal of the arcuate segments, the gear carriage 72 is pivoted at one end about a pin 92. A spring-biased shaft 94 biases the opposite end of the gear carriage 72 such that the gear 74 is biased into engagement with the rack gear 88. By displacing the shaft 94 upwardly in FIG. 10, the gear 74 is disengaged from the rack gear 88, enabling the segments to freely slide on the rollers 82 along the carriage 32. Carriage 32 also includes a pair of cable guide wheels 90 for guiding electrical cables, not shown, along the arcuate segments 36 for controlling the various motors of the external manipulator.

More specifically, referring to FIG. 9, the ends of the arcuate segments 36 have dovetail connections one with the other. That is, each female dovetail 83 may receive a male dovetail 85 of an adjoining segment such that the segments can be assembled within the casing 12. It will be appreciated that the distal end of the first inserted segment carries the robotic subassembly 39 including rail 38, shoulder gearbox 42, upper arm 44, forearm 46 and inspection tool 48. On the end of the distal segment 36, a pin connection is provided to secure the distal segment and the rail 38 to one another such that the rail 38 extends from the arcuate segment in a general axial direction (shown in FIGS. 6-8) and to opposite axial sides of the distal segment. The pin connection is illustrated in FIG. 13 by the female recess 96 and pin 97 coupled to a support secured to rail 38 intermediate opposite ends of the rail. At the distal end of rail 38 there is provided a gearbox 98 having a drive gear 100, an idler gear 101, and a driven gear 102. Gear 100 is driven directly by an electric motor 104 carried by rail 38. Drive gear 100 drives driven gear 102 through the idler gear 101. Mounted on gear 102 is a lead screw 108 extending the length of rail 38. A nut, not shown, fixed to the slider 40, is threaded about the lead screw 108. The slider 40 is mounted on rail 38 by rollers whereby the slider 40 traverses the length of rail 38 upon rotation of the lead screw 108.

Referring to FIGS. 14 and 15, the shaft 120 of the shoulder gearbox 42 is keyed and secured to the slider 40 at the projecting end 121, i.e., the shaft 120 does not rotate relative to slider 40. Consequently, the shaft 120 and shoulder gearbox 42 translate with slider 40 linearly along the rail 38 upon rotation of lead screw 108. The gearbox 42, however, rotates about shaft 120. To accomplish this, a gear 122 is rigidly mounted on the shaft 120, i.e., the shaft 120, gear 122 and slider 40 are rigidly connected with one another. A motor 124 is mounted on gearbox 42 and drives a gear 126 in engagement with gear 122. Since gear 122 is fixed to shaft 120, actuation of drive motor 124 rotates gears 126 and 122, causing the gearbox 42 to rotate about shaft 120, i.e., first axis 53 (shown in FIG. 6).

Additionally, the shoulder gearbox includes a motor 150 (shown in FIG. 14) for rotating the upper arm 44. The upper arm 44 is mounted on a bearing 152 surrounding a fixed stub shaft 154 coupled to the housing of the gear box 42. A thrust bearing 156 carries the upper arm 44 for rotation. A gear 158 is connected to the outer tube 160 of the upper arm 44 and engages a gear 162 on the shaft 164 of motor 150. Consequently, by actuating motor 150 in either direction, the gear drive rotates the upper arm 44 about its own axis, i.e., rotational axis 45 (shown in FIGS. 6 and 14).

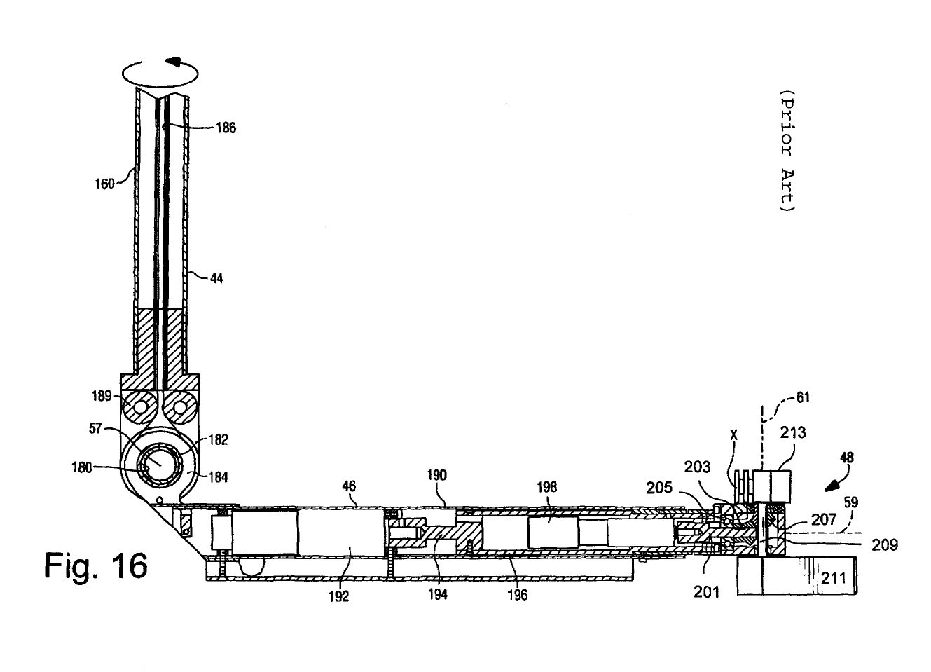

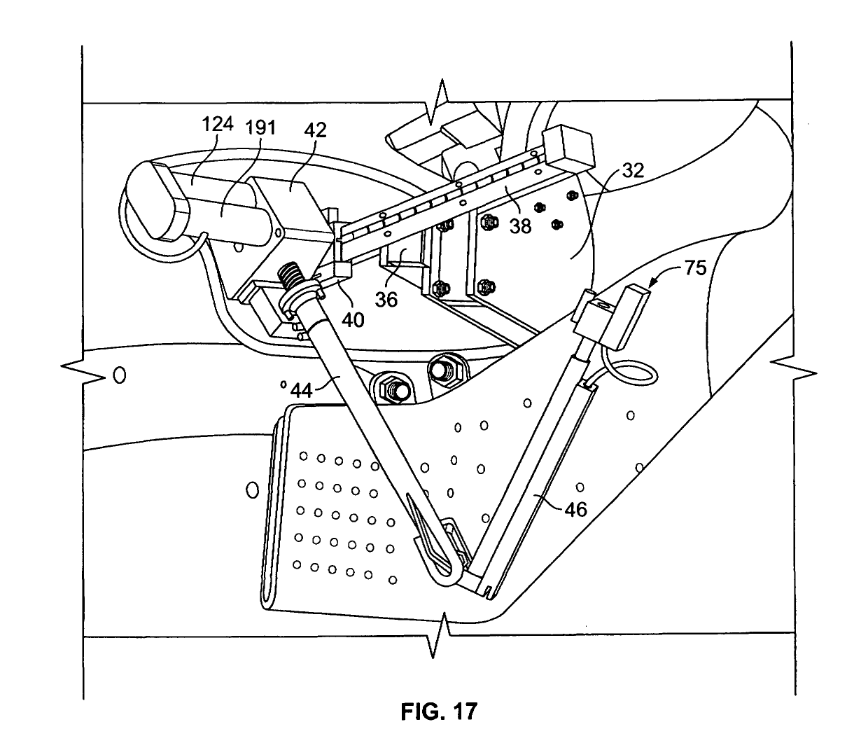

Referring to FIGS. 16 and 17, the forearm 46 is secured to the distal end of the upper arm 44 for pivotal movement about the second axis 57. Particularly, upper arm 44 carries a bearing sleeve 180 surrounded by a bushing 182 carried by the forearm 46. A drive pulley 184 is carried on the bushing 182 and cables 186 are wrapped about pulley 184 for pivoting the forearm 46 about axis 57 and relative to the upper arm 44. Particularly, cables 186 are wrapped about a cable drum 187 (shown in FIGS. 14 and 15) and extend past idler rolls 185 (shown in FIG. 14), through an interior guide tube 188, about idler rolls 189 and about drive pulley 184. To pivot the forearm 46 relative to the upper arm, a drive motor 191 (indicated by the dashed lines in FIG. 15) is mounted to gearbox 42 and has a drive shaft 193 carrying a gear 195. Gear 195 engages a gear 197 mounted for rotation on shaft 120. Gear 197 is coupled to cable drum 187. By actuating motor 191, the cable drum is rotated, driving the cables 186 and hence pivoting forearm 46 relative to upper arm 44 above second axis 57.

The forearm 46 preferably includes an outer tube 190 (shown in FIG. 16) to which is fixed a pan motor 192 internally within tube 190. The shaft 194 driven by motor 192 is connected to the proximal end of an interior rotatable tube 196 concentric within outer tube 190. The distal end of tube 196 is connected to the inspection head 48. Thus, actuation of motor 192 rotates inspection head 48 about the long axis of forearm 46, i.e., about a pan axis 59 (shown in FIGS. 6 and 16).

Within inner tube 196 is a tilt drive motor 198 which drives a shaft 201, in turn coupled to a bevel gear 203. The shaft 201 is mounted in a bearing 205, the outer race of which is carried by inner tube 196. Bevel gear 203 lies in meshing engagement with a driven bevel gear 207 mounted on a tilt axis shaft 209, suitable bearings being provided for the shaft 209. Actuation of motor 198 thus rotates inspection head 48 about the axis of shaft 209, i.e., about tilt axis 61 (shown in FIGS. 6 and 16). The inspection head 48 includes various instruments such as a camera 211 and a light assembly 213, both mounted on the shaft 209. In some embodiments, inspection head 48 includes a feeler gauge 75 mounted on shaft 209, as shown in FIG. 17. Consequently, actuation of tilt motor 198 rotates the camera, feeler gauge, and/or light assembly about the tilt axis to the desired positions.

In operation to inspect exterior surfaces of impingement sleeves 26, the exterior manipulator carriage 32 is disposed in the access opening 18 of the gas turbine and secured by securing the mast 34 to the casing 12. The first arcuate segment carrying the rail 38, gearbox 42, upper arm 44, forearm 46 and head 48 is inserted through the access opening and along carriage 32. The carriage 32 supports the assembly within the casing 12. The remaining arcuate segments 36 are connected to one another end-to-end by the dovetail connections and passed through carriage 32. With the upper arm 44 and forearm 46 folded against one another in a retracted position paralleling rail 38 and retracted along the rail to the proximal end thereof directly adjacent the end arcuate segment 36, the inspection head 48 can be advanced about a quadrant of the combustion casing and in a circumferential direction by actuation of motor 78 until it lies adjacent the impingement sleeve sought to be inspected. That is, the subassembly 39 is advanced in a circumferential direction in the radial space between the impingement sleeve 26 and the interior of casing 12 until it lies adjacent the impingement sleeve to be inspected. With the manipulator in the position illustrated in FIG. 7 between adjacent transition pieces and radially outwardly thereof, the upper arm 44 can be rotated and forearm 46 displaced from its folded position against upper arm 44 into positions to locate the inspection head 48 adjacent the area of the transition piece, i.e., impingement sleeve 26, to be inspected. For example, if the area to be inspected is to one side of the impingement sleeve, the drive motor 124 in the shoulder gearbox 42 is energized to rotate the shoulder gearbox 42 about shaft 120, i.e., axis 53. Additionally, the cable drum 126 is rotated by actuation of the motor 191 to pivot the forearm 46 relative to the upper arm 44 about axis 57 into the position illustrated in FIG. 8. Motor 104 is also actuated and displaces the shoulder gearbox 42 linearly along the rail 38. By translating the gearbox 42 along the rail 38, the axial position of the inspection head 48 in relation to the area desired to be inspected is obtained. Actuation of pan and tilt motors 192 and 198, respectively, position the inspection head 48 and particularly the camera and light assembly in registration with the desired inspection area. Consequently, visual inspection by video camera and measurements of the desired area are obtained. In the event the underside of the impingement sleeve is to be inspected, the shoulder gearbox 42 is rotated about axis 53 to locate the elbow, i.e., the joint between upper arm 44 and forearm 46 below, i.e., radially inwardly of, the impingement sleeve. Motor 191 is also actuated to rotate the forearm 46 about axis 57 to locate it below, i.e., radially inwardly of the impingement sleeve. Motor 150 is also actuated to rotate the upper arm 44 about its own axis 45, thus causing the forearm 46 to swing about the axis of upper arm 44 and below the impingement sleeve. By actuation of the pan and tilt motors 192 and 198, the camera and light assembly can be focused on the area sought to be inspected. Thus, it will be appreciated that by selective actuation of the various motors and positioning the exterior manipulator on opposite sides of the selected impingement sleeve, the entirety of the exterior surface of each of the impingement sleeves for each combustor can be visually inspected and measurements taken in situ. Note that the motors are all electrically driven remotely from outside the turbine casing through suitable electrical connections therewith. The motors can be actuated manually but are preferably computer controlled.

In some embodiments, in operation to inspect for gap 49 between wear pads 43 and forward frame 25, the exterior manipulator carriage 32 is disposed in the access opening 18 of the gas turbine and secured by securing the mast 34 to the casing 12. The first arcuate segment carrying the rail 38, gearbox 42, upper arm 44, forearm 46, and head 48 is inserted through the access opening and along carriage 32. Carriage 32 supports the assembly within the casing 12. The remaining arcuate segments 36 are connected to one another end-to-end by the dovetail connections and passed through carriage 32. With the upper arm 44 and forearm 46 folded against one another in a retracted position paralleling rail 38 and retracted along rail 38 to the proximal end thereof directly adjacent the end arcuate segment 36 as illustrated in FIG. 7, inspection head 48 can be advanced about a quadrant of the combustion casing 12 and in a circumferential direction by actuation of motor 78 until it lies adjacent the impingement sleeve 26 sought to be inspected. That is, the subassembly 39 is advanced in a circumferential direction in the radial space between the impingement sleeve 26 and the interior of casing 12 until it lies adjacent wear pad 45 to be inspected. With the manipulator in the position illustrated in FIG. 7 between adjacent transition pieces and radially outwardly thereof, the upper arm 44 can be rotated and forearm 46 displaced from its folded position against upper arm 44 into positions to locate the inspection head 48 adjacent the area of the transition piece, i.e., impingement sleeve 26, to be inspected. For example, if the area to be inspected is to one side of impingement sleeve 26, the drive motor 124 in the shoulder gearbox 42 is energized to rotate the shoulder gearbox 42 about shaft 120, i.e., axis 53. Additionally, the cable drum 126 is rotated by actuation of the motor 191 to pivot the forearm 46 relative to the upper arm 44 about axis 57 into the position illustrated in FIG. 17. Motor 104 is also actuated and displaces the shoulder gearbox 42 linearly along the rail 38. By translating the gearbox 42 along the rail 38, the axial position of the inspection head 48 in relation to the wear pad gap 49 desired to be inspected is obtained. Actuation of pan and tilt motors 192 and 198, respectively, position the inspection head 48 and particularly feeler gauge 75 in registration with the desired wear pad gap 49. Consequently, inspection by feeler gauge 75 and measurements of the desired wear pad gap 49 are obtained. In the event a wear pad gap 49 on the underside of the impingement sleeve 26 is to be inspected, the shoulder gearbox 42 is rotated about axis 53 to locate the elbow, i.e., the joint between upper arm 44 and forearm 46 below, i.e., radially inwardly of, the impingement sleeve. Motor 191 is also actuated to rotate the forearm 46 about axis 57 to locate it below, i.e., radially inwardly of the impingement sleeve 26. Motor 150 is also actuated to rotate the upper arm 44 about its own axis 45, thus causing the forearm 46 to swing about the axis of upper arm 44 and below the impingement sleeve 26. By actuation of the pan and tilt motors 192 and 198, feeler gauge 75 can be positioned to measure the wear pad gap 49 desired to be inspected. Thus, it will be appreciated that by selective actuation of the various motors and positioning the exterior manipulator on opposite sides of the selected impingement sleeve, wear gap pads 45 along the entirety of the circumference of the impingement sleeves for each combustor can be inspected and measurements taken in situ. Note that the motors are all electrically driven remotely from outside the turbine casing through suitable electrical connections therewith. The motors can be actuated manually but are preferably computer controlled.

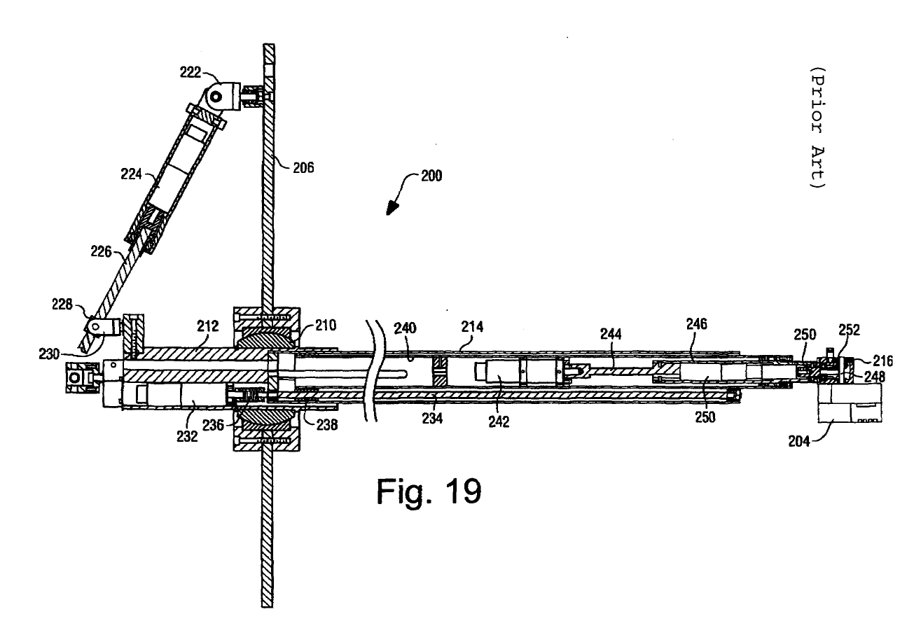

Referring now to FIGS. 18-20, there is illustrated an interior manipulator, generally designated 200, for inspecting the interior surface of the transition piece body 28. Referring to FIG. 18, the interior manipulator 200 includes a mount 202 at one end of the tool and an inspection head 204 at the opposite end of the tool carrying, for example, a similar camera and light assembly as the exterior manipulator. The mount 202 is in the form of a cross (shown in FIG. 19) having legs 206 90 degrees from one another. The legs 206 are mounted to the flanges of the combustion casing to secure the interior manipulator thereto. The central portion 208 of the mount 202 includes a spherical bearing 210 carried on a tubular section 212 projecting outwardly of the mount 202. On the inside of the mount 202 and carried by the tubular section 212 is an outer tube 214 for carrying the inspection head 204. In order to manipulate the inspection head 216 within the transition piece body 28, a pair of linear actuators 220 are coupled between the outer ends of a pair of legs 206, respectively, and the outer end of the tubular section 212. Particularly, each linear actuator 220 is pivotally secured to a clevis 222 mounted to the outer end of a leg 206. The actuator 220 includes a motor 224 which drives a lead screw 226 engaged in a threaded nut 228 mounted on a hinge 230. The hinge 230 is, in turn, mounted on the tubular section 212. By locating the linear actuators 220 90° apart, it will be appreciated that actuation of the motors 224 pivots the inspection head 216 about the spherical bearing 210 toward and away from the transition piece body 28.

Additionally, by extending or retracting the inspection head 204, the inspection head can be located adjacent any interior surface portion of the transition piece body 28. To accomplish the telescoping movement, a motor 232 is carried by the tubular section 212. Motor 232 drives a lead screw 234 via a shaft coupling 236. A lead screw nut 238 is secured to an inner tube 240 concentric with outer tube 214. By actuating motor 232 and rotating lead screw 234 in engagement with nut 238, tube 240, which mounts the inspection head 204, can be advanced and retracted in an axial direction.

To rotate the inspection head 204 about its own axis, i.e., to pan the inspection head, a pan motor 242 drives a shaft 244, in turn coupled to a tube 246 carrying the inspection head 204. Thus, by actuating motor 242 and rotating shaft 244, tube 246 and head 204 are rotated about the axis of the outer tube 214. To rotate the inspection head 204 about a tilt axis 248, a tilt motor 250 is provided and drives the inspection head about axis 248 through a shaft and beveled gear connection 250 and 252, respectively, similarly as previously described with respect to the exterior manipulator. It will be appreciated that the section 212 and tubes, i.e., members 214, 240 and 246 are collectively called the inspection arm.

The operation of the interior manipulator is believed self-evident from the foregoing description. Upon securing mount 202 of the interior manipulator to the flange of the combustor, actuation of the linear motors 224 and 232 locate the inspection head 204 closely adjacent to a selected interior surface portion of the transition piece body sought to be inspected. By actuating motors 242 and 250, the inspection head is rotated about pan and tilt axes and directed such that the light assembly illuminates the surface portion to be inspected by the video camera of head 204.

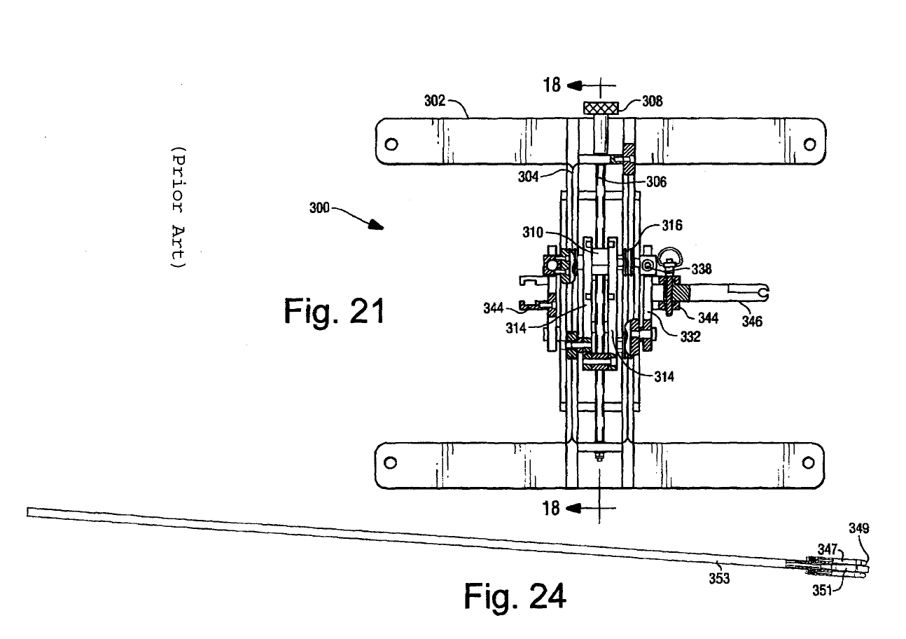

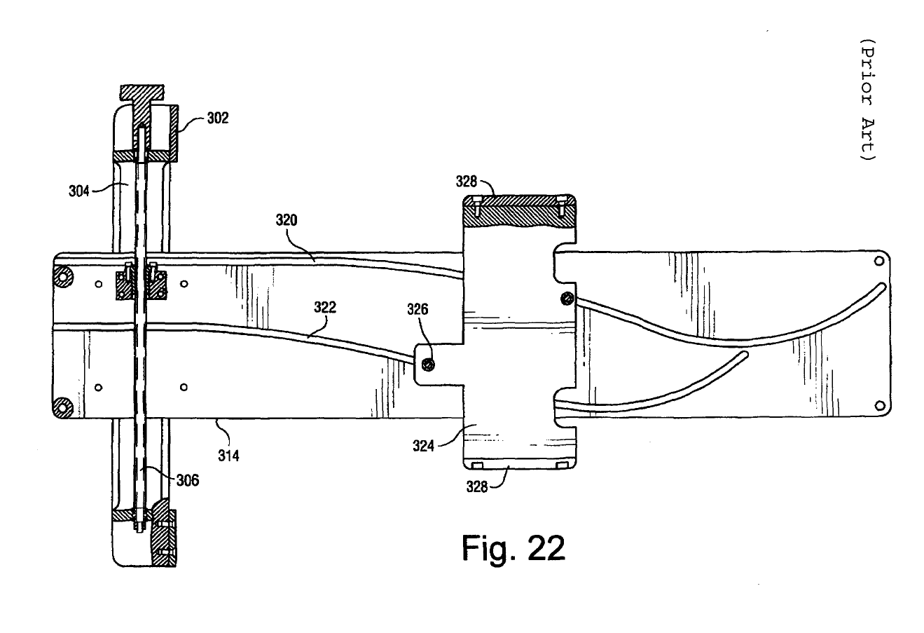

Referring now to the annulus manipulator illustrated in FIGS. 21-24, the inspection head which preferably carries a camera and a light assembly similar to the previously described inspection heads is positioned in the annulus 30 between the transition piece body 28 and the impingement sleeve 26. The annulus manipulator is specifically configured to inspect the side seam weld 29 along opposite sides of the transition piece body, and/or to inspect wear pad gap 49 between wear pads 43 and forward frame 25. It will be appreciated the transition piece body 28 is fabricated in upper and lower halves, with the halves being welded together along weld lines 29 which essentially follow the contour of the shaped upper and lower exterior surfaces of the transition piece body 28. To inspect those welds 29, the annulus manipulator, generally designated 300, includes a pair of mounting plates 302 which are secured by bolts during inspection to the flanges of the combustor casing. Between the mounting plates 302, there is provided a pair of spaced V-rails 304. Extending centrally between the rails 304 is a lead screw 306, terminating at one end in a manually rotatable knob 308 supported by one of the mounting plates 302. The opposite end of the lead screw 306 is journalled into the opposing mounting plate 302. Lead screw 306 extends through a lead nut block 310, secured between and to a pair of spaced guide plates 314. The guide plates 314 are secured to one another by suitable spacers at longitudinally located positions along the lengths of the plates and serve as a guide for guiding an inspection head 347 along the side seam weld 29. Additionally, rollers 316 are provided on the outside of the guide plates 314 for bearing against the rails 304 to maintain the plates 314 in extended positions from the mounting plates 302 as illustrated in FIG. 22. By operation of the knob 308, the guide plates 314 can be displaced accurately toward and away from opposite sides of the transition piece upon insertion of the annulus manipulator into the transition piece.

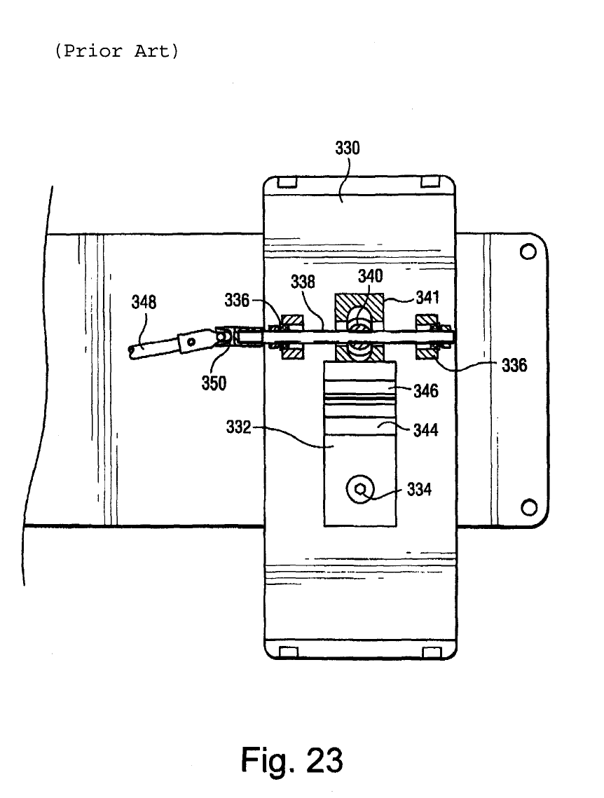

As best illustrated in FIG. 22, each of the guide plates 314 includes a pair of longitudinally extending contoured surfaces, i.e., grooves 320 and 322. The grooves of each plate 314 register with corresponding grooves of the opposite plate. Disposed between the guide plates 314 is a middle carriage plate 324 which carries a pair of guide pins 326 projecting from each of its opposite sides and engaging in the grooves 320 and 322, respectively. It will be appreciated that the middle carriage plate 324 is slidable lengthwise along the spaced guide plates 314 and along the grooves 320 and 322 of the guide plates 314, the middle carriage plate 324 serving as a cam follower with respect to the contoured surfaces 320 and 322. Opposite ends of the middle carriage plate 324 mount transversely extending end carriage plates 328. Along the outside side faces of the guide plates 314 are side carriage plates 330 (shown in FIG. 23) which extend between the outer edges of the end carriage plates 328. Thus, the middle carriage plate 324 and end carriage plates 328 form essentially an I-beam with the side carriage plates 330 extending parallel to the middle carriage plate 324 and between end edges of the end carriage plates 328 along outside surfaces of the guide plates 314.

On each of the exterior surfaces of the side carriage plates 330, there is provided an arm 332 pivotal about a pin 334. Each side carriage plate 330 mounts a pair of bearings 336 through which a lead screw 338 is rotatable. Lead screw 338 is rotatable on a nut 340 pivotally carried on the upper end of arm 332. Nut 340 is also movable vertically relative to its mounting 341 on arm 332. By rotating the lead screw, the nut 340 causes the arm 332 to pivot about pin 334 to provide a finite adjustable angular movement of the inspection head, as described below.

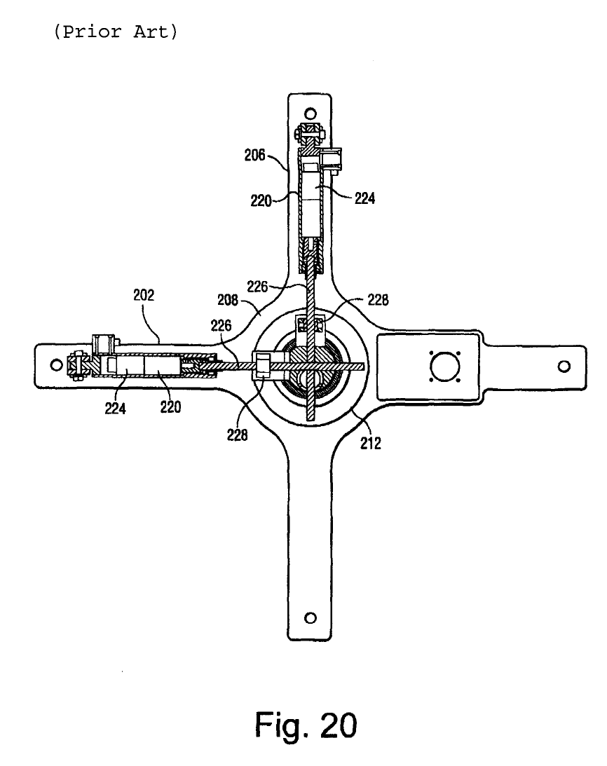

On each side of each side carriage plate 330, there is provided a mounting block 344 (shown in FIGS. 21 and 23). A wand holder 346 is pinned to one of the mounting blocks 344. The lateral outer end of the wand holder 346 is adapted to receive a wand tube 348, illustrated in FIG. 20, on the end of which is mounted an inspection head 347. Head 347 includes a light assembly 349 and a video camera 351.

A carriage handle 348 is coupled by a universal joint 350 with the lead screw 338, the handle 348 extending the length of the annulus manipulator for manipulation externally thereof. By rotating the carriage handle 348, the arm 332 carrying the wand tube 348 in the wand holder 346 can be pivoted to finitely locate the inspection head 347 along the weld seam 29.

In operation, using the annulus manipulator to inspect the side seam weld 29 along opposite sides of the transition piece body 28, the mounting plate 302 is secured to the flange of the combustion casing, with the middle and side carriage plates 324 and 330, respectively, extending into the transition piece, terminating short of the transition piece body 28. The wand tube 353 with the inspection head 347 is mounted to the wand holder 346 extends the length of the annulus manipulator. The middle and side carriage plates are jointly advanced along the guide plates 314 by pushing on the carriage handle 348. The inspection head 347 is thus guided into the space between the transition piece body 28 and the impingement sleeve 26. As the inspection head 347 is advanced into the annulus, the side carriage plates 330 are guided by the movement of the middle carriage plate 324 along the grooves 320 and 322 to follow the contour of the side seam weld 29. With the inspection head mounted on one of the side carriage plates 330, the inspection head likewise follows the contour of the side seam weld 29. The video camera and light assembly forming part of inspection head 347 thus register with the side weld 29 and record the integrity of the side seam weld. By threading or unthreading the lead screw 338, the angle of the camera 351 and light assembly 349 can be finitely adjusted within the annulus to view appropriate areas on either side of the weld seam and/or to ensure registration of the camera and light assembly with the weld. After the inspection of one side weld seam, the annulus manipulator is retracted and the wand carrying the inspection head 347 is secured to the mounting block 344 carried by the other side carriage plate 330. The plates 324 and 330 are then advanced following the contours of the grooves 320 and 322 whereby the inspection head traverses along and inspects the opposite side weld seam.

In operation, using the annulus manipulator to inspect wear pad gap 49 between wear pads 43 and forward frame 25, the mount 302 is secured to the flange of the combustion casing, with the middle and side carriage plates 324 and 330, respectively, extending into the transition piece, terminating short of the transition piece body 28. The wand tube 353 with the inspection head 347 is mounted to the wand holder 346 extends the length of the annulus manipulator. The middle and side carriage plates are jointly advanced along the guide plates 314 by pushing on the carriage handle 348. The inspection head 347 is thus guided into the space between the transition piece body 28 and the impingement sleeve 26. As the inspection head 347 is advanced into the annulus, the side carriage plates 330 are guided by the movement of the middle carriage plate 324 along the grooves 320 and 322 to a position adjacent a wear pad 45 that is desired to be inspected. With the inspection head mounted on one of the side carriage plates 330, the inspection head likewise is positioned adjacent the desired wear pad 45. The video camera and light assembly forming part of inspection head 347 thus register with the wear pad 45 desired to be inspected and/or the wear pad gap 49 desired to be inspected. By threading or unthreading the lead screw 338, the angle of the camera 351 and light assembly 349 can be finitely adjusted within the annulus to view the desired wear pad 45 and/or the desired wear pad gap 49 to ensure registration of the camera and light assembly with the pad 45 and/or gap 49. In some embodiments, a light source 95 (shown in FIG. 5) is configured to illuminate a portion of an exterior side 407 (shown in FIG. 5) of impingement sleeve 26 adjacent the wear pad gap 49 desired to be inspected. The light coming through wear pad gap 49 may then be detected on the opposite interior side 409 (shown in FIG. 5) of impingement sleeve 26 to determine the wear pad gap 49. In some embodiments, a light source 411 (shown in FIG. 5) is configured to illuminate a portion of interior side 409 of impingement sleeve 26 adjacent the wear pad gap 49 desired to be inspected. A shadow cast by the wear pad 45 may then be measured to determine the wear pad gap 49. The gap and measurement may be determined by examining where the shadow of the wear pad gap is cast on the wear pad surface. By determining were the shadow is, and obtaining the relationship of the camera and light to the wear pad, the gap can be determined. The focal plane method uses the small depth of field of a camera to discriminate the distance of an object from the objective lens being that everything on that plane will be at the same focal length. The operator focuses the camera on the wear pad and then on the interior side of the impingement sleeve where the wear pad would make contact. If the wear pad and the interior side of the impingement sleeve are not on the same focal plane, then there is a gap. Using feedback of lens position or other means, a gap size can be established. The camera is remotely focusable and has a very short depth of field.

The embodiments described and/or illustrated herein are applicable to evaluating any type of sensor and/or to controlling any apparatus of a group of a plurality of apparatus.

Exemplary embodiments are described and/or illustrated herein in detail. The embodiments are not limited to the specific embodiments described herein, but rather, components and steps of each embodiment may be utilized independently and separately from other components and steps described herein. Each component, and each step, can also be used in combination with other components and/or method steps.

When introducing elements/components/etc. described and/or illustrated herein, the articles “a”, “an”, “the”, “said”, and “at least one” are intended to mean that there are one or more of the element(s)/component(s)/etc. The terms “comprising”, “including” and “having” are intended to be inclusive and mean that there may be additional element(s)/component(s)/etc. other than the listed element(s)/component(s)/etc.

While the invention has been described in terms of various specific embodiments, those skilled in the art will recognize that the invention can be practiced with modification within the spirit and scope of the claims.

1. A method for in situ inspection of a wear pad gap in a gas turbine engine combustor, wherein the wear pad gap is defined between a wear pad of a transition piece impingement sleeve and a forward ring of a flow duct of the combustor, said method comprising:
coupling a guide to the combustor such that the guide at least partially extends within a space between the impingement sleeve and a body of the transition piece;
displacing an inspection head along the guide within the space between the impingement sleeve and the transition piece body such that the inspection head is positioned adjacent a wear pad; and
inspecting the wear pad gap.

2. A method in accordance with claim 1 wherein displacing an inspection head along the guide comprises displacing the inspection tool along a longitudinal axis of the impingement sleeve.

3. A method in accordance with claim 1 further comprising remotely recording the results from inspecting the wear pad gap.

4. A method in accordance with claim 1 wherein inspecting the wear pad gap comprising visually inspecting the wear pad gap.

5. A method in accordance with claim 4 wherein visually inspecting the wear pad gap comprises visually inspecting the wear pad gap using a camera.

6. A method in accordance with claim 4 wherein visually inspecting the wear pad gap comprises illuminating an exterior side of the impingement sleeve adjacent the wear pad, and detecting light coming through the wear pad gap on an opposite interior side of the impingement sleeve.

7. A method in accordance with claim 4 wherein visually inspecting the wear pad gap comprises illuminating an interior side of the impingement sleeve adjacent the wear pad, and measuring a shadow cast by the wear pad.

8. A method in accordance with claim 4 wherein visually inspecting the wear pad gap comprises a focusable camera configured to discern whether the elements of the wear pad gap are the same distance from the cameras objective lens.

9. Apparatus for inspecting in situ a wear pad gap in a gas turbine engine combustor, wherein the wear pad gap is defined between a wear pad of a transition piece impingement sleeve and a forward ring of a flow duct of the combustor, said apparatus comprising:
an elongate guide;
a mount for coupling said guide to the combustor such that said guide at least partially extends within a space between the impingement sleeve and a body of the transition piece and such that a portion of said guide extends adjacent the wear pad;
a cam follower coupled to said guide for movement along said guide;
an inspection head carried by said cam follower, said inspection head comprises a feeler gauge coupled thereto for measuring the wear pad gap, wherein said inspection head is adjacent to an exterior side of the impingement sleeve; and
an actuator coupled to said cam follower for displacing said cam follower along said guide.

10. Apparatus in accordance with claim 9 wherein said elongate guide extends along a longitudinal axis of the impingement sleeve.

11. Apparatus in accordance with claim 9 further comprising an arm adjustably coupled on said cam follower and carrying said inspection head for adjusting a location of said inspection head relative to said guide and the wear pad.

12. Apparatus in accordance with claim 9 further comprising a camera coupled to said inspection head for visually inspecting the wear pad gap.

13. Apparatus in accordance with claim 9 further comprising a light source configured to be illuminate a portion of an exterior side of the impingement sleeve adjacent the wear pad.

14. Apparatus in accordance with claim 9 further comprising a light source configured to be illuminate a portion of an interior side of the impingement sleeve adjacent the wear pad.

15. Apparatus for inspecting in situ a wear pad gap in a gas turbine engine combustor, wherein the wear pad gap is defined between a wear pad of a transition piece impingement sleeve and a forward ring of a flow duct of the combustor, and wherein a casing of the combustor includes an opening for accessing an external side of the impingement sleeve, said apparatus comprising:
a manipulator having an arcuate segment and a carriage for supporting said segment within the casing;
a rail carried by said segment;
a first arm carried by said rail for translatory movement therealong and pivotal movement relative to said rail about a first axis generally normal to the axis of rotation of the gas turbine engine;
a second arm coupled at one end to said first arm for pivotal movement about a second axis normal to a plane containing said first arm and said second arm; and
an inspection head carried by said second arm adjacent an opposite end thereof for pivotal movement about pan and tilt axes perpendicular to one another, said inspection head configured to be positioned adjacent the wear pad gap on the exterior side of the impingement sleeve, wherein said inspection head comprises a feeler gauge coupled thereto for measuring the wear pad gap.

16. Apparatus in accordance with claim 15 wherein said segment comprises a plurality of discrete, arcuate segments connected endwise to one another and extending arcuately about the combustor, a slider for sliding along said rail, a gearbox carried by said slider and slidable along said rail with said slider, said first arm being connected to said gearbox, said gearbox housing a shaft fixed to said slider and having a gear, and a motor carried by said gearbox for driving said gear to rotate said gearbox, said first and second arms, and said inspection head about said fixed shaft.

17. Apparatus in accordance with claim 15 wherein said first arm is elongated and carried by said rail for rotation about an axis extending lengthwise along said first arm.

18. Apparatus in accordance with claim 15 wherein said second arm is elongated and is rotatable about an axis extending lengthwise along said second arm.

19. A method for in situ inspection of a wear pad gap in a gas turbine engine combustor, wherein the wear pad gap is defined between a wear pad of a transition piece impingement sleeve and a forward ring of a flow duct of the combustor, said method comprising:
inserting a robotic inspection tool carrying an inspection head through an opening in an outer casing of the combustor;
robotically manipulating the tool from a location external of the casing to locate the inspection head adjacent the wear pad on an exterior side of the impingement sleeve;
inspecting the wear pad gap using a feeler gauge on the inspection head; and
after completion of the inspection, withdrawing the inspection tool from within the outer casing.
